(19) United States
(12) Patent Application Publication
(10) Pub. No.: US 2026/0342230 A1
(43) Pub. Date: Oct. 29, 2026

(54) BOOST CONVERTER/ LIGHT-EMITTING DIODE (LED) DRIVER WITH PREDETERMINED PEAK-CURRENT-BASED CONTROL

(71) Applicant: CIRRUS LOGIC INTERNATIONAL SEMICONDUCTOR LTD., Edinburgh (GB)

(72) Inventors: Xin Zhao, Austin, TX (US); Xiaofan Fei, Austin, TX (US); Eric J. King, Austin, TX (US); Lei Zhu, Austin, TX (US); Evan Schulz, Austin, TX (US)

(21) Appl. No.: 19/654,410

(22) Filed: Apr. 21, 2026

Related U.S. Application Data
(60) Provisional application No. 63/797,054, filed on Apr. 29, 2025.

(51) Int. Cl. H02M 3/158; H02M 1/00; H05B 45/38

(52) U.S. Cl. CPC H02M 3/158; H02M 1/0003; H05B 45/38

(57) ABSTRACT

A method implemented by a control circuit of a boost converter provides a simplified mechanism for alternating between discrete-conduction mode (DCM) and continuous-conduction mode (CCM) operation. In response to an output voltage of the boost converter being less a predetermined threshold voltage, a magnetic storage element is coupled across an input power source until a predetermined peak current level is reached, at which time the magnetic storage device is coupled to boost converter output to discharge the magnetic storage device. The discharge is terminated if a zero current level is reached. A cycle timer times the discharge, and charging and discharging continues to alternate if the cycle timer indicates that a constant off-time period has expired during the discharge while the voltage of the output of the boost converter is less than a second higher threshold voltage.

### FIELD OF THE DISCLOSURE

The field of representative embodiments of this disclosure relates to boost converter circuits and control methods for boost converters, and in particular, to a boost converter control scheme that uses a predetermined peak current level to control operation, and light-emitting diode (LED) diode drivers that incorporate the boost converter control techniques.

### BACKGROUND

Personal audio devices, including wireless telephones, such as mobile/cellular telephones, cordless telephones, mp3 players, wireless headphones, wireless earbuds, smart watches, and other consumer audio devices, are in widespread use. Such personal devices may include circuitry for driving a pair of headphones or one or more speakers. Such circuitry often includes a speaker driver including a power amplifier for driving an audio output signal to headphones or speakers. Furthermore, such personal devices may include devices for personal health monitoring, in which the health monitoring system may include circuitry for driving light emitting diodes (LEDs). Such systems often include LEDs and audio power amplifiers coupled to supplies generated by power converters from a battery.

Typically, power supplies for such audio devices and LED drivers for driving the LEDs are implemented as switched-power converters, and boost converter topologies are frequently chosen for their power converters due to the need to generate a higher voltage from a lower battery voltage. A requirement for low output ripple is typical due to a need to avoid flicker in LEDs and to avoid audio distortion in audio power output stages in the face of highly variable output current loading. A requirement for simplicity of the power converter controller is driven by a need for a low ripple controller that is both efficient and lacks complexity, but has high efficiency for battery-operated systems.

Therefore, it would be advantageous to provide a boost converter circuit having a simplified control method with low power supply output ripple and high efficiency.

### SUMMARY

The objectives of simplified control, high efficiency, and low ripple are accomplished in a simplified control scheme for operating a boost converter circuit that are included in a boost converter circuit and its method of operation.

The method includes: responsive to an output voltage of the boost converter being less than a first predetermined threshold voltage, charging a magnetic storage device until a predetermined peak current level is reached, and discharging the magnetic storage device into an output of the boost converter. The discharging is terminated if a zero current level through the magnetic storage device is reached. The charging, discharging and terminating steps are repeated, in sequence, if a constant off-time period has expired during each cycle of the discharging and while a voltage of the output of the boost converter is less than a second predetermined threshold voltage having a magnitude greater than a magnitude of the first predetermined threshold voltage.

The method may be implemented by a state machine that maintains the boost converter in a first phase in which both the charging switch and the discharging switch of the boost converter are off while an output voltage of the boost converter is greater than a first predetermined threshold voltage, responsive to the output voltage of the boost converter being less than the first predetermined threshold voltage, enters a second phase of charging a magnetic storage device of the boost converter by controlling an on-time of the charging switch of the boost converter according to a current level in a magnetic storage device of the boost converter to reach a predetermined peak current level. The state machine disables the charging switch in response to the current level in the magnetic storage device reaching the predetermined peak current level, enters a third phase of operating the discharge switch of the boost converter according to whether the current level has either reached a zero current level or a constant off-time period has elapsed, disables the discharge switch if the current level has reached the zero current level and returns to the first phase. Responsive to the constant off-time period having elapsed, the state machine determines whether or not the voltage of the output of the boost converter exceeds a second predetermined threshold voltage having a magnitude greater than a magnitude of the first predetermined threshold voltage, and responsive to determining that the voltage of the output of the boost converter exceeds the second predetermined threshold voltage, enters a fourth phase of maintaining the discharge switch in an enabled condition until the current level has reached the zero current level, and returns to the first phase of operation. The state machine, responsive to determining that the voltage of the output of the boost converter does not exceed the second predetermined threshold voltage, disables the discharging switch to re-enter the second phase.

The summary above is provided for brief explanation and does not restrict the scope of the claims. The description below sets forth example embodiments according to this disclosure. Further embodiments and implementations will be apparent to those having ordinary skill in the art. Persons having ordinary skill in the art will recognize that various equivalent techniques may be applied in lieu of, or in conjunction with, the embodiments discussed below, and all such equivalents are encompassed by the present disclosure.

### BRIEF DESCRIPTION OF THE DRAWINGS

FIG. 1 is a simplified schematic diagram illustrating an example boost converter circuit 10, in accordance with an embodiment of the disclosure.

FIG. 2 is a block diagram illustrating an example boost controller circuit 14 that may be used to implement example boost converter circuit 10 of FIG. 1, in accordance with an embodiment of the disclosure.

FIG. 3A and FIG. 3B are signal waveform diagrams 30A and 30B, respectively, illustrating an example operation of example boost converter circuit 10 of FIG. 1, in accordance with an embodiment of the disclosure.

FIG. 4 is a state diagram 40 illustrating an example operation of example boost converter circuit 10 of FIG. 1, in accordance with an embodiment of the disclosure.

FIG. 5 is a signal waveform diagram 50 illustrating an example operation of boost converter circuit 10 of FIG. 1, in accordance with an embodiment of the disclosure.

FIG. 6 is a signal waveform diagram 60 illustrating an example operation of boost converter circuit 10 of FIG. 1, in accordance with an embodiment of the disclosure.

FIG. 7 is a simplified schematic diagram illustrating another example boost converter circuit 10A, in accordance with another embodiment of the disclosure.

### DETAILED DESCRIPTION

The present disclosure encompasses boost converter power supply circuits/light-emitting diode driver circuits and integrated circuits that incorporate the circuits and their methods of operation. The control of the boost converter and the method of operation provide a simplified mechanism for alternating between discontinuous-conduction mode (DCM) and continuous-conduction mode (CCM) operation. In response to an output voltage of the boost converter being less than a predetermined threshold voltage, a magnetic storage element is coupled across an input power source until a predetermined peak current level is reached, at which time the magnetic storage device is coupled to boost converter output to discharge the magnetic storage device. The discharge is terminated if a zero current level is reached. A cycle timer times the discharge, and charging and discharging continues to alternate if the cycle timer indicates that a constant off-time period has expired during the discharge while the voltage of the output of the boost converter is less than a second higher threshold voltage.

The boost converter circuits disclosed herein are load current dependent boost control circuits, which may be used to implement boost drivers, such as LED boost drivers, and which may be used for providing low current levels in a battery-operated device. Only two comparators are required for controlling the magnetic storage element (e.g., inductor) current control and slope compensation is not required. The boost converter is robust and has no sub-harmonic oscillation, reliable due to the peak current monitoring, has fast transient behavior, since it is immune to rapid changes in the load current or input voltage, and has low quiescent power, requiring only one comparator be active to commence a cycle during idle states. The boost converter circuits also have high efficiency, since they may operate only in discontinuous-conduction mode (DCM) or pseudo-continuous conduction mode (CCM) mode, depending on load conditions, and the performance metrics of the converters may be tuned based on load conditions. By combining predetermined peak current control and constant off-time hysteretic voltage regulation, switching activity may be reduced and quiescent efficiency is improved.

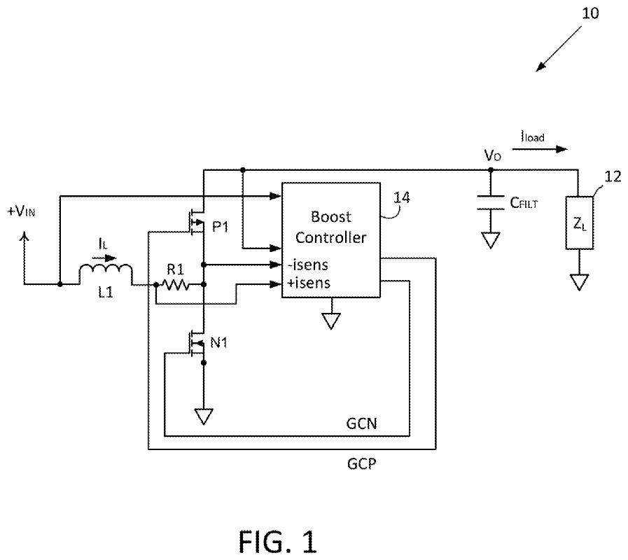

Referring now to FIG. 1, a simplified schematic diagram illustrating an example boost converter circuit 10, is shown in accordance with an embodiment of the disclosure. Example boost converter circuit 10 includes a magnetic storage element, which in the example is an inductor L1, coupled between an input terminal that receives an input and a pair of switching transistors P1 and N1. Transistor N1 is used to “charge” inductor L1 by conducting current through inductor L1 from power supply voltage +V_{IN} to ground to build up stored magnetic energy, and transistor P1 is used to “discharge” inductor L1 to release the stored magnetic energy by generating a current through transistor P1 that charges an output filter capacitor C_{FILT}. Since inductor L1 remains coupled to power supply voltage +V_{IN}, the voltage across output filter capacitor C_{FILT} may reach a magnitude of twice the magnitude of power supply voltage +V_{IN}, “boosting” power supply voltage +V_{IN}. Control of switching of transistor N1 and transistor P1 is provided by a boost controller IC 14 that, in accordance with the embodiments disclosed below, alternatively charges and discharges inductor L1 to maintain an output voltage V_{O} across output filter capacitor C_{FILT} and any load 12 connected to output filter capacitor C_{FILT}. Boost controller IC 14 generates a gate control signal GCP that controls the gate of transistor P1, and a gate control signal GCN that controls the gate of transistor N1. On average, the current provided from inductor L1 will be equal to a load current I_{load} drawn from boost converter circuit 10 by load 12, in order to maintain output voltage V_{O} at a constant level. A resistor R1 is connected in series with inductor L1 to produce a measurement voltage across sense terminals +isense, −isense of boost controller 14, which uses the measurement voltage as an indication of a level of inductor current I_{L} conducted through inductor L1.

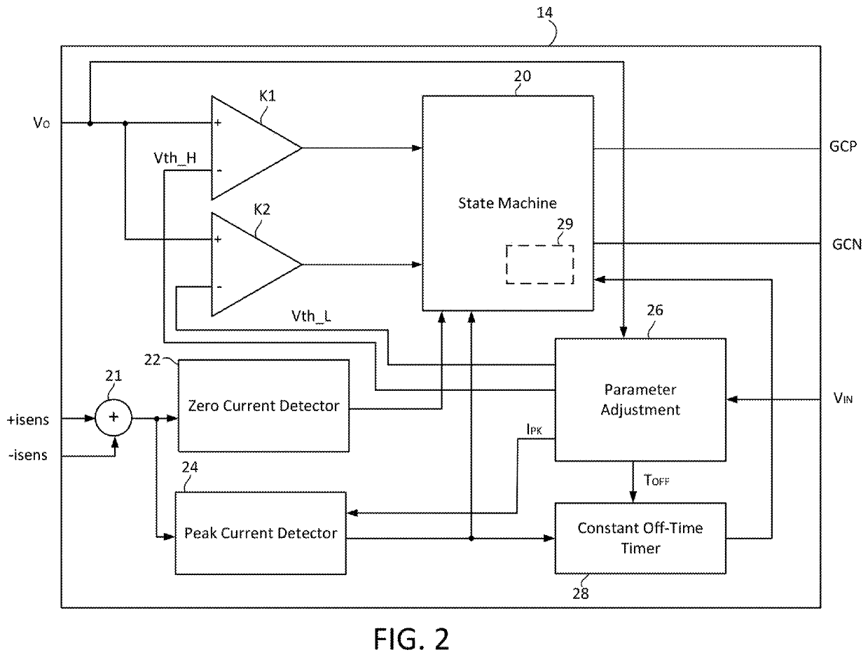

Referring additionally now to FIG. 2, a block diagram illustrating an example boost controller circuit 14 that may be used to implement example boost converter circuit 10 of FIG. 1, is shown in accordance with an embodiment of the disclosure. A state machine 20 generates gate control signals GCP, GCN in accordance with comparisons of output voltage V_{O} to two threshold voltage levels: a lower threshold voltage V_{th_L}, which triggers a transition from an idle state when a magnitude of output voltage V_{O} is less than lower threshold voltage V_{th_L}, and an upper threshold voltage V_{th_H}, which terminates discharging of inductor L1 when magnitude of output voltage V_{O} is reaches upper threshold voltage V_{th_H}, with |V_{th_H}|>|V_{th_L}|, which is V_{th_H}>V_{th_L} for the depicted embodiment, which generates a positive output voltage V_{O}. A comparator K1 compares output voltage V_{O} to lower threshold voltage V_{th_L}, and a comparator K2 compares output voltage V_{O} to upper threshold voltage V_{th_H} to generate control inputs to state machine 20. Lower threshold voltage V_{th_L} upper threshold voltage V_{th_H} are provided to state machine 20 from a parameter adjustment module 26 that sets lower threshold voltage V_{th_L} and upper threshold voltage V_{th_H} according to operating conditions such as the magnitude of input voltage V_{IN}. For particular designs, lower threshold voltage V_{th_L} and upper threshold voltage V_{th_H} are generally fixed values, but may be varied under some conditions.

Discharge of inductor L1 is also terminated under other conditions, according to details of operation of state machine 20 as described in further detail below. The measurement voltage across sense terminals +isense, −isense is determined by a subtractor 21, which may be, for example, a differential amplifier subtractor, and is provided to a zero current detector 22 that determines when the inductor current is zero, i.e., inductor L1 is completely discharged, and a peak current detector 24, which detects when inductor L1 has been charged to a predetermined stored energy level LI_{PK}²/2, where I_{PK} is a peak current value, which may be fixed for a particular design, or which may be generated or retrieved by parameter adjustment block 26, which may provide a peak current control signal I_{PK} that sets a peak current level used by peak current detector 24. A constant off-time timer 28 counts a time from the start of a discharge cycle as indicated by peak current detector 24 indicating that the predetermined peak current level I_{PK} has been reached, and when boost converter 10 is operating in a pseudo-continuous conduction mode, referred to herein as continuous conduction mode (CCM), causes termination of a discharge cycle before the energy stored in inductor L1 has reached zero. Determination between operating in DCM or CCM is made based upon the operating state of boost converter 10 is described in further detail below.

Parameter adjustment block 26 operates according to a function that maps the operating condition of boost converter 10 (input voltage V_{IN}, output voltage V_{O}, and load current I_{load}) to the control variables of boost converter 10 (peak current level I_{PK}, constant off-time T_{OFF}, lower threshold voltage V_{th_L} and upper threshold voltage V_{th_H}). Pseudo-CCM operation is active when the constant off-time T_{OFF} is shorter than the time required for inductor current I_{L} to ramp down to zero when switching transistor P1 is enabled. DCM operation is active when the constant off-time T_{OFF} is longer than the time required for inductor current I_{L} to ramp down to zero when switching transistor P1 is enabled. Critical conduction mode (CrCM) operation occurs when constant off-time T_{OFF} is equal to the time required for the inductor current to ramp down to zero when switching transistor P1 is enabled. Operating parameters of boost converter 10 may be determined/selected as follows. Constant off-time T_{OFF} may be determined from known input and output voltages and an approximate switching frequency. Peak current level I_{PK} may be determined from a known load current of boost converter 10. A difference between input voltage V_{IN} and output voltage V_{O} is also used in determination of operating parameters. Switching may occur when output voltage V_{O} falls below the low voltage threshold and stops when the voltage reaches the high voltage threshold (i.e., switching turns off). Selection of a targeted peak inductor current I_{PK} may be adjusted to improve the following: maximum output current delivery capacity, output voltage ripple under light load conditions, boost converter efficiency, hysteresis-loop boost converter active-inactive switching frequency. Determination/selection of peak inductor current I_{PK} may map a known output load current I_{LOAD} to peak current I_{PK}. For example, selection/determination of peak current I_{PK} may select a higher peak current to achieve a required capacity for large load current I_{LOAD}, and may select a lower peak current I_{PK} to reduce output voltage ripple for low output current I_{LOAD}. Providing a load dependent, predetermined peak current during charging provides key information to optimize efficiency, output accuracy and frequency of boost converter 10. In one example embodiment, peak current I_{PK} is set to a lower value when load current I_{LOAD} is lower, improving the output accuracy, and I_{PK} is set to a higher value when load current load current I_{LOAD} is higher, providing higher output current and higher efficiency. Lower threshold voltage V_{th_L} and upper threshold voltage V_{th_H} may be determined/selected based on target values of output voltage V_{O} and a target frequency of operation of boost converter 10. In one example embodiment, output voltage V_{O} may desirably be a minimum of 5.2V, so that lower threshold voltage V_{th_L} is set to 5.2V, and higher threshold voltage V_{th_H} may be set to 5.24V, based on a target operating (switching) frequency.

The operating frequency of boost converter 10 may also be monitored (active-inactive switching frequency) and peak current I_{PK} may be adjusted to maintain the operating frequency outside of predetermined “keep-out” frequency bands. Constant off-time T_{OFF} and/or the hysteresis voltage, i.e., the difference between upper threshold voltage V_{th_H} and lower threshold voltage V_{th_L} may be determined/selected based on a known output load current I_{LOAD}. Parameter adjustment block 26 may include a look-up table that performs selections of the operating parameters, for simplicity and efficiency, or may perform computation of operating parameter functions that determine the operating parameters. Parameter adjustment block 26 optionally includes a pulse-frequency detection block 27 that measures the pulse frequency of boost converter 10 and one or more of the peak current I_{PK}, constant off-time T_{OFF}, or the hysteresis voltage V_{th_H}−V_{th_L} to maintain a keep-out zone, which reduces noise generated in the keep-out zone. In one example embodiment, a second timer 29 is included to time a predetermined period and if zero-current detector 22 indicates that inductor current I_{L} has reached a zero value before the predetermined period has elapsed, an indication that the inductance of inductor L1 is too low and outside of tolerance may be generated.

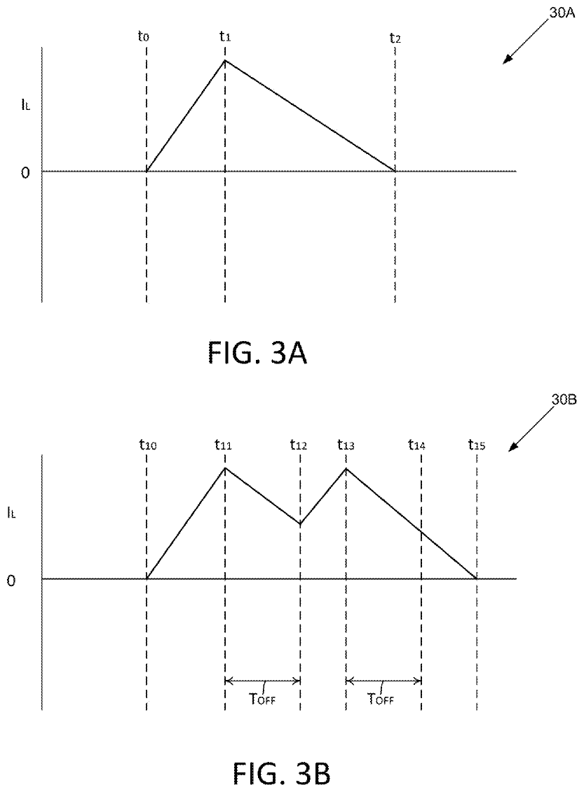

Referring now to FIG. 3A and FIG. 3B, signal waveform diagrams 30A and 30B, respectively, illustrating an example operation of example boost converter circuit 10 of FIG. 1, are shown in accordance with an embodiment of the disclosure. FIG. 3A is an example of boost converter 10 operation in a single cycle of DCM operation. At a time t₀, in a charging cycle, while switching transistor N1 is active, inductor current I_{L} ramps upward until at a time t₁, predetermined peak current level I_{PK} is reached, causing switching transistor N1 to be deactivated and switching transistor P1 to be activated, commencing a discharge cycle in which inductor current I_{L} ramps down to zero, which occurs at a time t₂. FIG. 3B is an example of boost converter 10 operation in pseudo-CCM operation. At a time t₁₀, in a charging cycle, while switching transistor N1 is active, inductor current I_{L} ramps upward until at a time t₁₁, predetermined peak current level I_{PK} is reached, causing switching transistor N1 to be deactivated and switching transistor P1 to be activated, commencing a discharge cycle in which inductor current I_{L} ramps down until predetermined off-time period T_{OFF} has elapsed at a time t₁₂, terminating the discharge cycle. Another charging cycle commences, with inductor current I_{L} ramping upward, until at time a time t₁₃, predetermined peak current level I_{PK} is again reached, commencing another discharge cycle, which continues until after predetermined off-time period T_{OFF} has elapsed at a time t₁₄, (due to output voltage V_{O} not exceeding upper threshold voltage V_{th_H}—not shown), until at a time t₁₅, at which inductor current I_{L} reaches zero, terminating the discharge cycle.

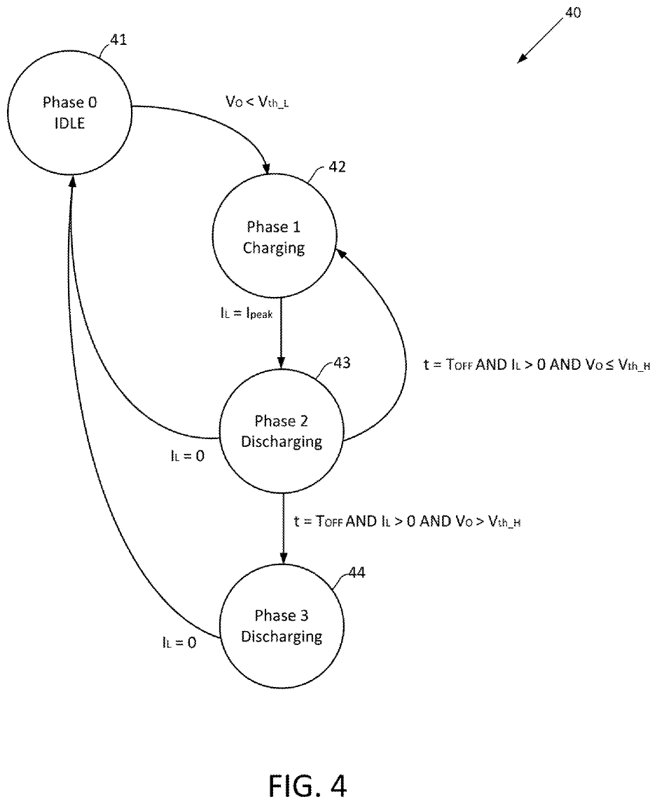

Referring now to FIG. 4, a state diagram 40 illustrating an example operation of example boost converter circuit 10 of FIG. 1, is shown in accordance with an embodiment of the disclosure. As illustrated, boost converter 10 operates according to four phases: a first phase 41 (Phase 0) in which boost converter is idle, i.e., switching transistors P1 and N1 are both deactivated, a second phase 42 (Phase 1) in which switching transistor N1 is active, charging inductor L1, a third phase 43 (Phase 2), in which switching transistor P1 is active, discharging inductor L1, and a fourth phase 44 (Phase 3), in which switching transistor P1 is active, discharging inductor L1. Transition from Phase 0 41 is conditioned upon output voltage V_{O} falling below lower threshold voltage V_{th_L}, and the transition is to the charging phase, Phase 1 42, which is exited upon inductor current I_{L} reaching predetermined peak current level I_{PK}. In response to inductor current I_{L} reaching predetermined peak current level I_{PK}, discharging phase, Phase 3 44, commences charging output filter capacitor C_{FILT}, which continues until either predetermined off-time period T_{OFF} has elapsed, output voltage V_{O} rises above upper threshold voltage V_{th_H}, or inductor current I_{L} has ramped down to zero. If output voltage V_{O} rises above upper threshold voltage V_{th_H}, or inductor current I_{L} reaches zero, boost converter 10 operates in DCM, entering idle phase Phase 0 41, until output voltage V_{O} again falls below lower threshold voltage V_{th_L}. If, instead, predetermined off-time period T_{OFF} elapses first while inductor current I_{L} is still greater than zero, and output voltage V_{O} is above upper threshold voltage V_{th_H}, boost converter 10 prepares to enter DCM, entering discharging phase Phase 3 44, until inductor current I_{L} reaches zero, terminating the discharge cycle and entering idle phase Phase 0 41. If predetermined off-time period T_{OFF} elapses while inductor current I_{L} is still greater than zero and output voltage V_{O} is below or equal to upper threshold voltage V_{th_H}, discharge Phase 2 43 is terminated, and operation enters charging Phase 1 42 again, operating in CCM. Following the above rules, the operation of boost converter 10 may follow and repeat the sequence of phases {0, 1, 2} or phases {0, 1, 2, 3}, or {0, 1, 2, 1, 2 . . . , 3}, with repetitions of phases 1 and 2 until inductor current I_{L} reaches zero or output voltage V_{O} exceeds upper threshold voltage V_{th_H}. The example operation of the embodiment is simple and uses less components for the boost converter. Therefore, it uses lower power. The phase transition decision at the end of phase 2 is critical to achieve faster and accurate responses, and provides higher efficiency. Phase 3 and the transition to DCM mode is required to maintain energy balance in the magnetic storage element, preventing charging when additional output current is not required.

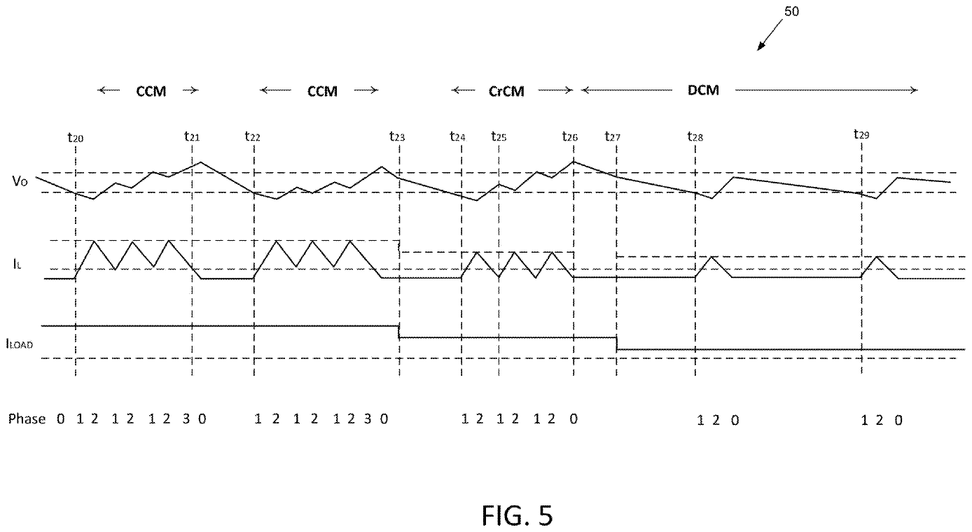

FIG. 5 is a signal waveform diagram 50 illustrating an example operation of boost converter circuit 10 of FIG. 1, in accordance with an embodiment of the disclosure. At a time t₂₀, output voltage V_{O} falls below lower threshold voltage V_{th_L} a charging cycle commences, and CCM operation with alternating charging and discharging cycles occurs until a time t₂₁, when output voltage V_{O} has risen above upper threshold voltage V_{th_H}. Another burst of CCM operation (thus, pseudo-CCM operation) commences at a time t₂₂, when output voltage V_{O} again falls below lower threshold voltage V_{th_L}. At a time t₂₃, a step in load current I_{LOAD} occurs, and the next burst of operation occurs when output voltage V_{O} again falls below lower threshold voltage V_{th_L} at a time t₂₄. When inductor current I_{L} reaches zero at the same time that predetermined off-time period T_{OFF} expires, operation is at the critical conduction mode point (CrCM), with inductor current I_{L} just reaching zero at expiration of the predetermined off-time T_{OFF} at e.g., time t₂₅. At a time t₂₆, output voltage V_{O} has risen above upper threshold voltage V_{th_H} and operation enters the idle state. At a time t₂₇, another step in load current I_{LOAD} occurs, and the next burst of operation occurs when output voltage V_{O} again falls below lower threshold voltage V_{th_L} at a time t₂₈, but only DCM cycles occur at time t₂₈ and another time t₂₉ due to the reduced load current I_{LOAD} demand. Each of the above modes of operation may have a corresponding characteristic pulse frequency, e.g., DCM pulse frequency, CrCM pulse frequency and CCM pulse frequency and parameters of boost converter 10 may be adjusted when one of the characteristic frequencies falls within a keep-out frequency range. The characteristic frequencies vary with load current I_{LOAD} and input voltage V_{IN}, and may require dynamic evaluation and parameter adjustment to avoid generation of noise in the keep-out frequency ranges. The constant off-time used may be generated based upon input voltage V_{IN} and output voltage V_{O}, according to T_{OFF}=V_{IN}/(V_{O} f_{sw}), where f_{sw} is the switching frequency, which adapts operation to maintain desired switching behavior and optimize efficiency.

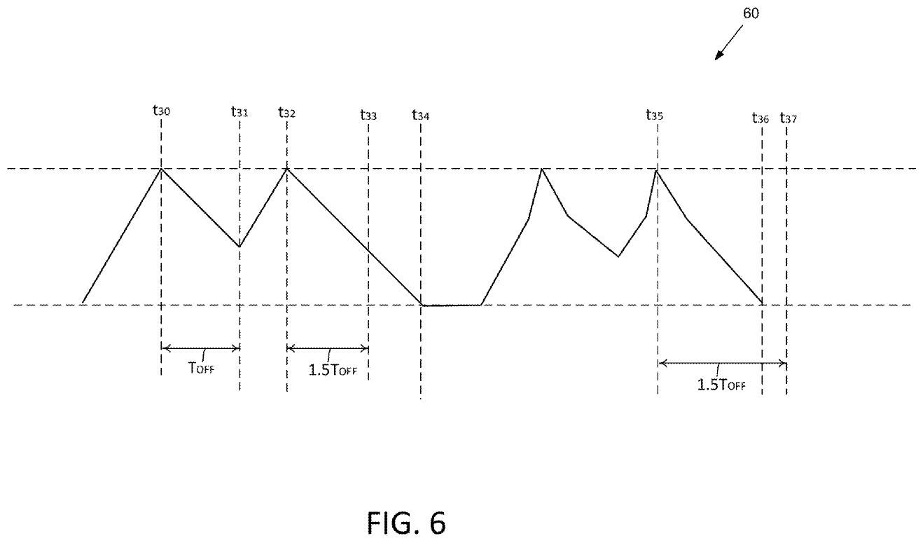

FIG. 6 is a signal waveform diagram 60 illustrating an example operation of boost converter circuit 10 of FIG. 1, in accordance with an embodiment of the disclosure. Saturation of inductor L1 reduces output current delivery to an amount less than a predicted level since less energy is stored in inductor L1 during charging phases. Inductor saturation may be detected by comparing predetermined constant off time T_{OFF}, illustrated between a time t₃₀ and a time t₃₁, to a time margin, e.g., a multiple of 1.5 time T_{OFF}, which extends from t₃₂ to time t₃₃. For the unsaturated condition depicted from t₃₂ to time t₃₄, the discharge time is greater than 1.5T_{OFF}, however for saturating operating condition, as depicted between time t₃₅ and a time t₃₆, the saturating condition may be determined by detecting that the zero-inductor-current times, e.g., time t₃₆, occur before the detection time at time t₃₇, and appropriate parameter adjustment may be made, e.g., reduction of peak current value I_{PK} may be made to prevent saturation. Detecting inductor saturation aids in preventing thermal run-away, which may damage boost converter 10.

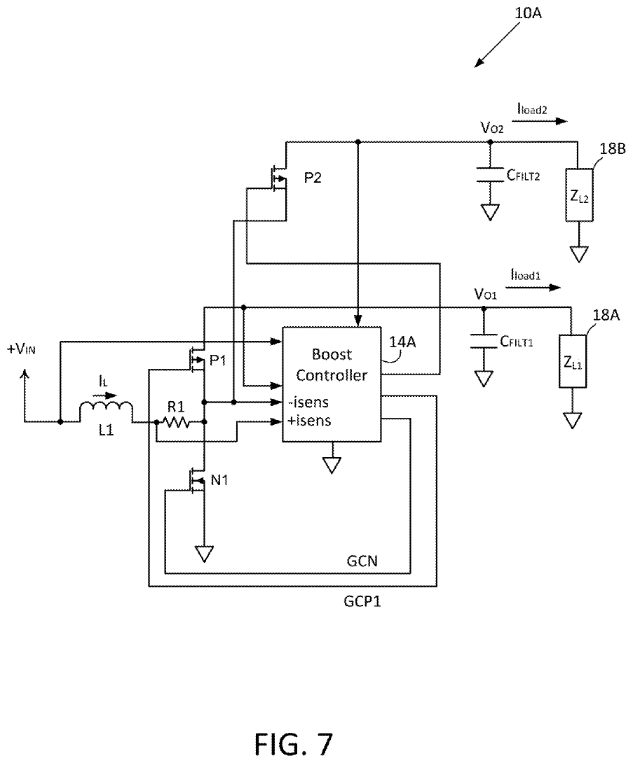

FIG. 7 is a simplified schematic diagram illustrating another example boost converter circuit 10A, in accordance with another embodiment of the disclosure. Example boost converter circuit 10A is an example of a multi-output boost converter that incorporates the techniques disclosed herein, according to an embodiment of the disclosure. Boost converter circuit 10A is similar to boost converter circuit 10 of FIG. 1, so only differences between them will be described below. Boost converter circuit 10A includes two discharging transistors P1, P2 that alternatively charge two output filter capacitors C_{FILT1}, C_{FILT2} to two separate output voltages V_{O1},V_{O2}, which may have different magnitudes and/or polarity, or which may be otherwise identical, to provide power supply isolation/rejection between different circuits represented by their respective loads 18A, 18B. A boost controller IC 14 operates as described above, except for alternatively charging output filter capacitors C_{FILT1}, C_{FILT2}, which may be in strict alternation, or which may, for example, operate primarily in DCM with cycles allocated according to the currents demanded provided by loads 18A, 18B.

In summary, this disclosure shows and describes methods of operation of boost converter circuits and boost converter circuits that, in response to an output voltage of the boost converter being less than a first predetermined threshold voltage, charge a magnetic storage device until a predetermined peak current level is reached. The magnetic storage device is then discharged into an output of the boost converter, and the discharge is terminated if a zero current level through the magnetic storage device is reached. The charging and discharging is continued in sequence if a constant off-time period has expired during each cycle of the discharging and while a voltage of the output of the boost converter is less than a second predetermined threshold voltage having a magnitude greater than a magnitude of the first predetermined threshold voltage.

In some example embodiments, the boost converter may operate in discontinuous-conduction mode (DCM) while the constant off-time period does not expire for cycles of the boost converter, and the boost converter my operate in continuous-conduction mode (CCM) while the constant off-time period has expired. In some example embodiments, the method may select a value of the constant off-time period in conformity with a magnitude of an input voltage provided to the boost converter, a target output voltage of the boost converter, and a switching frequency of the boost converter. In some example embodiments, the method may detect a frequency of operation of the boost converter, determine whether or not the frequency of operation falls in one or more frequency ranges to be avoided, and responsive to determining that the frequency of operation falls in one or more frequency ranges to be avoided, adjust one or more of the predetermined peak current level, the constant off-time period or a difference between the second predetermined threshold voltage and the first predetermined threshold voltage.

In some example embodiments, the method may measure a time interval between commencing the discharging and the zero current level being reached in the magnetic storage device, compare the time interval to a threshold time value determined from the constant off-time period, to determine whether the magnetic storage device is saturating. The method may, in response to determining the magnetic storage device is saturating, limit the current level through the magnetic storage device to prevent thermal runaway. In other example embodiments, the method may reduce the predetermined peak current level to prevent thermal runaway. In some example embodiments, the method may set the predetermined peak current level in conformity with a specified load current level of the boost converter.

In some example embodiments, the method may select from among multiple outputs of the boost converter, and perform the charging, the discharging, and the terminating steps for the selected output of the boost converter. The method may repeat the selecting and performing of the charging, the discharging, and the terminating steps for each of the multiple outputs. In some example embodiments, the method may further set the predetermined peak current level to different values in accordance with the selection of the output of the boost converter. In some example embodiments, the method may further set one or more of the first predetermined threshold voltage, the second predetermined threshold voltage, and the constant off-time period to different values in accordance with the selection of the output of the boost converter.

The disclosure also shows and describes methods and circuits that maintain the boost converter in a first phase in which both a charging switch and a discharging switch of the boost converter are off while an output voltage of the boost converter is greater than a first predetermined threshold voltage, and responsive to the output voltage of the boost converter being less than the first predetermined threshold voltage, charge a magnetic storage device of the boost converter in a second phase by controlling an on-time of a charging switch of the boost converter according to a current level in a magnetic storage device of the boost converter to reach a predetermined peak current level. The charging switch may couple the magnetic storage device in series with an input of the boost converter, and the charging switch may be disabled in response to the current level in the magnetic storage device reaching the predetermined peak current level. The method may operate a discharge switch of the boost converter in a third phase according to whether the current level has either reached a zero current level or a constant off-time period has elapsed, and the discharge switch may couple the magnetic storage element to an output of the boost converter, may be disabled if the current level has reached the zero current level, and the method may return to the first phase of operation. The method may, responsive to the constant off-time period having elapsed, determine whether or not the voltage of the output of the boost converter exceeds a second predetermined threshold voltage having a magnitude greater than a magnitude of the first predetermined threshold voltage, and responsive to determining that the voltage of the output of the boost converter exceeds the second predetermined threshold voltage, maintain the discharge switch in an enabled condition in a fourth phase until the current level has reached the zero current level and returning to the first phase of operation. The method may, responsive to determining that the voltage of the output of the boost converter does not exceed the second predetermined threshold voltage, disable the discharging switch to re-enter the second phase.

In some example embodiments, the method may further include responsive to determining that the voltage of the output of the boost converter does not exceed the first predetermined threshold voltage when the current through the magnetic storage device has reached the zero current level, increasing the predetermined peak current level. In some example embodiments, the method may further comprise prior to performing the charging, determining whether or not the voltage of the output of the boost converter exceeds the first predetermined threshold voltage. The charging may be performed responsive to determining that the voltage of the output of the boost converter does not exceed the first predetermined threshold voltage, and the boost converter may enter the first phase as an idle state in response to determining that the voltage of the output of the boost converter exceeds the first predetermined threshold voltage. In some example embodiments, the transitions between phases of operation of the boost converter correspond to selection of operation between continuous conduction mode (CCM) and discontinuous conduction mode (DCM) conditioned on whether the zero current level is reached prior to expiration of the constant off-time period.

While the disclosure has shown and described particular embodiments of the techniques disclosed herein, it will be understood by those skilled in the art that the foregoing and other changes in form, and details may be made therein without departing from the spirit and scope of the disclosure. For example, the techniques shown above may be applied to another type of switched-power system.

What is claimed is:

1. A method of operating a boost converter, comprising:
responsive to an output voltage of the boost converter being less than a first predetermined threshold voltage, charging a magnetic storage device until a predetermined peak current level is reached;
discharging the magnetic storage device into an output of the boost converter;
terminating the discharging if a zero current level through the magnetic storage device is reached; and
continuing the charging, discharging and terminating steps, in sequence, if a constant off-time period has expired during each cycle of the discharging and while a voltage of the output of the boost converter is less than a second predetermined threshold voltage having a magnitude greater than a magnitude of the first predetermined threshold voltage.

2. The method of claim 1, wherein the boost converter operates in discontinuous-conduction mode (DCM) while the constant off-time period does not expire for cycles of the boost converter, and wherein the boost converter operates in continuous-conduction mode (CCM) while the constant off-time period has expired.

3. The method of claim 1, further comprising selecting a value of the constant off-time period in conformity with a magnitude of an input voltage provided to the boost converter, a target output voltage of the boost converter, and a switching frequency of the boost converter.

4. The method of claim 1, further comprising:
detecting a frequency of operation of the boost converter;
determining whether or not the frequency of operation falls in one or more frequency ranges to be avoided; and
responsive to determining that the frequency of operation falls in one or more frequency ranges to be avoided, adjusting one or more of the predetermined peak current level, the constant off-time period or a difference between the second predetermined threshold voltage and the first predetermined threshold voltage.

5. The method of claim 1, further comprising:
measuring a time interval between commencing the discharging and the zero current level being reached in the magnetic storage device;
comparing the time interval to a threshold time value determined from the constant off-time period, to determine whether the magnetic storage device is saturating; and responsive to determining the magnetic storage device is saturating, limit the current level through the magnetic storage device to prevent thermal runaway.

6. The method of claim 1, further comprising:
measuring a time interval between commencing the discharging and the zero current level being reached in the magnetic storage device;
comparing the time interval to a threshold time value determined from the constant off-time period, to determine whether the magnetic storage device is saturating; and responsive to determining the magnetic storage device is saturating, reduce the predetermined peak current level to prevent thermal runaway.

7. The method of claim 1, further comprising:
selecting from among multiple outputs of the boost converter;
performing the charging, the discharging, and the terminating steps for the selected output of the boost converter; and
repeating the selecting and performing of the charging, the discharging, and the terminating steps for each of the multiple outputs.

8. The method of claim 7, wherein the selecting further sets the predetermined peak current level to different values in accordance with the selection of the output of the boost converter.

9. The method of claim 7, wherein the selecting further sets one or more of the first predetermined threshold voltage, the second predetermined threshold voltage, and the constant off-time period to different values in accordance with the selection of the output of the boost converter.

10. The method of claim 1, further comprising setting the predetermined peak current level in conformity with a specified load current level of the boost converter.

11. A method of operating a boost converter, comprising:
maintaining the boost converter in a first phase in which both a charging switch and a discharging switch of the boost converter are off while an output voltage of the boost converter is greater than a first predetermined threshold voltage;
responsive to the output voltage of the boost converter being less than the first predetermined threshold voltage, charging a magnetic storage device of the boost converter in a second phase by controlling an on-time of a charging switch of the boost converter according to a current level in a magnetic storage device of the boost converter to reach a predetermined peak current level, wherein the charging switch couples the magnetic storage device in series with an input of the boost converter, and wherein the charging switch is disabled in response to the current level in the magnetic storage device reaching the predetermined peak current level;
operating a discharge switch of the boost converter in a third phase according to whether the current level has either reached a zero current level or a constant off-time period has elapsed, wherein the discharge switch couples the magnetic storage element to an output of the boost converter and is disabled if the current level has reached the zero current level and returning to the first phase of operation;
responsive to the constant off-time period having elapsed, determining whether or not the voltage of the output of the boost converter exceeds a second predetermined threshold voltage having a magnitude greater than a magnitude of the first predetermined threshold voltage;
responsive to determining that the voltage of the output of the boost converter exceeds the second predetermined threshold voltage, maintaining the discharge switch in an enabled condition in a fourth phase until the current level has reached the zero current level and returning to the first phase of operation; and
responsive to determining that the voltage of the output of the boost converter does not exceed the second predetermined threshold voltage, disabling the discharging switch to re-enter the second phase.

12. The method of claim 11, further comprising responsive to determining that the voltage of the output of the boost converter does not exceed the first predetermined threshold voltage when the current through the magnetic storage device has reached the zero current level, increasing the predetermined peak current level.

13. The method of claim 11, further comprising prior to performing the charging, determining whether or not the voltage of the output of the boost converter exceeds the first predetermined threshold voltage, wherein the charging is performed responsive to determining that the voltage of the output of the boost converter does not exceed the first predetermined threshold voltage, and wherein the boost converter enters the first phase as an idle state in response to determining that the voltage of the output of the boost converter exceeds the first predetermined threshold voltage.

14. The method of claim 11, wherein transitions between phases of operation of the boost converter correspond to selection of operation between continuous conduction mode (CCM) and discontinuous conduction mode (DCM) conditioned on whether the zero current level is reached prior to expiration of the constant off-time period.

15. A boost converter circuit, comprising:
an input terminal for receiving power supply input;
a magnetic storage device having a first terminal coupled to the input terminal;
a switching circuit that alternatively couples a second terminal of the magnetic storage device between a power supply return and an output of the boost converter circuit and an off state;
a comparison circuit for comparing a voltage of the output of the boost converter circuit to a first predetermined threshold and a second predetermined threshold having a magnitude greater than a magnitude of the first predetermined threshold voltage; and
a control circuit having an input coupled to an output of the comparison circuit that, responsive to the comparison circuit indicating that an output voltage of the boost converter is less than the first predetermined threshold voltage, controls the switching circuit to couple the second terminal of the magnetic storage device to the power supply return to charge the magnetic storage device until a predetermined peak current level is reached through the magnetic storage device, couples the second terminal of the magnetic storage device to the output of the boost converter to discharge the magnetic storage device, sets the switching circuit to the off state if a zero current level through the magnetic storage device is reached to terminate the discharge of the magnetic storage device, wherein the control circuit comprises a cycle timer for timing a period of the discharge of the magnetic storage device, and wherein the control circuit continues to operate the switching circuit to repeat the charging, discharging, and termination of the discharging, in sequence, if the cycle timer indicates that a constant off-time period has expired during each cycle of the discharging while the comparison circuit indicates that the voltage of the output of the boost converter is less than the second predetermined threshold voltage.

16. The boost converter circuit of claim 15, wherein the boost converter circuit operates in discontinuous-conduction mode (DCM) while the constant off-time period does not expire for cycles of the boost converter, and wherein the boost converter circuit operates in continuous-conduction mode (CCM) while the constant off-time period has expired.

17. The boost converter circuit of claim 15, wherein the control circuit further selects a value of the constant off-time period in conformity with a magnitude of a voltage of the power supply input provided to the boost converter, a target output voltage of the boost converter, and a switching frequency of the boost converter.

18. The boost converter circuit of claim 15, wherein the control circuit comprises a frequency detector that detects a frequency of operation of the boost converter, wherein the control circuit determines whether or not the frequency of operation falls in one or more frequency ranges to be avoided, and wherein the control circuit, responsive to determining that the frequency of operation falls in one or more frequency ranges to be avoided, adjusts one or more of the predetermined peak current level, the constant off-time period or a difference between the second predetermined threshold voltage and the first predetermined threshold voltage.

19. The boost converter circuit of claim 15, wherein the control circuit further measures a time interval between commencing the discharging and the zero current level being reached in the magnetic storage device, compares the time interval to a threshold time value determined from the constant off-time period, to determine whether the magnetic storage device is saturating, and responsive to determining the magnetic storage device is saturating, limits the current level through the magnetic storage device to prevent thermal runaway.

20. The boost converter circuit of claim 15, wherein the control circuit further measures a time interval between commencing the discharging and the zero current level being reached in the magnetic storage device, compares the time interval to a threshold time value determined from the constant off-time period, to determine whether the magnetic storage device is saturating, and responsive to determining the magnetic storage device is saturating, reduces the predetermined peak current level to prevent thermal runaway.

21. The boost converter circuit of claim 15, wherein the boost converter has multiple outputs, wherein the control circuit selects from among the multiple outputs, controls the switching circuit to charge and discharge the storage element, and terminate the discharge for the selected output of the boost converter, and repeats the selection among the multiple outputs and controls the switching circuit to charge and discharge the storage element, and terminate the discharge for each of the multiple outputs.

22. The boost converter circuit of claim 21, wherein the control circuit further sets the predetermined peak current level to different values in accordance with the selection from among of the multiple outputs of the boost converter.

23. The boost converter circuit of claim 21, wherein the control circuit further sets one or more of the first predetermined threshold voltage, the second predetermined threshold voltage, and the constant off-time period to different values in accordance with the selection from among the multiple outputs of the boost converter.

24. The boost converter circuit of claim 15, wherein the predetermined peak current level is set in conformity with a specified load current level of the boost converter.

25. A boost converter circuit, comprising:
an input terminal for receiving power supply input;
a magnetic storage device having a first terminal coupled to the input terminal;
a switching circuit that alternatively couples a second terminal of the magnetic storage device between a power supply return with a charging switch and an output of the boost converter circuit with a discharging switch;
a comparison circuit for comparing a voltage of the output of the boost converter circuit to a first predetermined threshold and a second predetermined threshold having a magnitude greater than a magnitude of the first predetermined threshold voltage; and
a control circuit having an input coupled to an output of the comparison circuit and that includes a state machine that maintains the boost converter in a first phase in which both the charging switch and the discharging switch of the boost converter are off while an output voltage of the boost converter is greater than a first predetermined threshold voltage, responsive to the output voltage of the boost converter being less than the first predetermined threshold voltage, enters a second phase of charging a magnetic storage device of the boost converter by controlling an on-time of the charging switch of the boost converter according to a current level in a magnetic storage device of the boost converter to reach a predetermined peak current level, and wherein the charging switch is disabled in response to the current level in the magnetic storage device reaching the predetermined peak current level, enters a third phase of operating the discharge switch of the boost converter according to whether the current level has either reached a zero current level or a constant off-time period has elapsed, wherein the discharge switch is disabled if the current level has reached the zero current level and returns to the first phase, and responsive to the constant off-time period having elapsed, determines whether or not the voltage of the output of the boost converter exceeds a second predetermined threshold voltage having a magnitude greater than a magnitude of the first predetermined threshold voltage, and responsive to determining that the voltage of the output of the boost converter exceeds the second predetermined threshold voltage, enters a fourth phase of maintaining the discharge switch in an enabled condition until the current level has reached the zero current level and returns to the first phase of operation, and responsive to determining that the voltage of the output of the boost converter does not exceed the second predetermined threshold voltage, disables the discharging switch to re-enter the second phase.

26. The boost converter circuit of claim 25, wherein the control circuit further increases the predetermined peak current level in response to the comparison circuit determining that the voltage of the output of the boost converter does not exceed the first predetermined threshold voltage when the current through the magnetic storage device has reached the zero current level.

27. The boost converter circuit of claim 25, wherein the control circuit activates the charging switch only if the comparison circuit indicates that the voltage of the output of the boost converter does not exceed the first predetermined threshold voltage, and wherein the boost converter enters the first phase as an idle state if the voltage of the output of the boost converter exceeds the first predetermined threshold voltage.

28. The boost converter circuit of claim 25, wherein the control circuit changes phases of operation of the boost converter to select between continuous conduction mode (CCM) and discontinuous conduction mode (DCM) conditioned on whether the zero current level is reached prior to expiration of the constant off-time period.
